(19) United States
(12) Patent Application Publication
(10) Pub. No.: US 2013/0189093 A1
(43) Pub. Date: Jul. 25, 2013

(54) MULTI-PIECE TWIN SCROLL TURBINE

(71) Applicant: Robert Andrew Wade, Dearborn, MI (US)

(72) Inventor: Robert Andrew Wade, Dearborn, MI (US)

(73) Assignee: Ford Global Technologies, LLC, Dearborn, MI (US)

(21) Appl. No.: 13/356,523

(22) Filed: Jan. 23, 2012

(51) Int. Cl. F01D 1/02; B23P 15/00

(52) U.S. Cl. 415/204; 29/889.22

(57) ABSTRACT

A turbine is provided. The turbine includes a housing radially extending around a turbine rotor including a first piece defining a portion of a first scroll passage boundary and a second piece having an interface wall contiguous with an interface wall of the first piece, the second piece coupled to the first piece and including a divider defining another portion of the first scroll passage boundary and a portion of a second scroll passage boundary.

### BACKGROUND/SUMMARY

Turbochargers may be used in engines to increase the engine's power to weight ratio by increasing charge air density into the cylinder via a compressor, the compressor powered by exhaust flow through a turbine. The flow path of exhaust gas entering the turbine may be adjusted during engine operation to better match turbine characteristics to current engine operating conditions. For example, twin scroll turbines have been developed including two scrolls for delivering exhaust gas to the turbine rotor and a valve configured to adjust the flow-rate of the exhaust gas through the scrolls.

For example, US 2010/0229551 discloses a twin scroll turbocharger. The scroll passages each have different geometries, enabling the losses in the turbine to be decreased during a variety of operating conditions. The housing defining the boundary of the scroll passages includes a divider separating the first scroll passage from the second scroll passage. The housing, including the divider, is formed from a single continuous piece of material.

The Inventor has recognized several drawbacks with the turbocharger design disclosed in US 2010/0229551. As one example, highly accurate positioning of the divider within the housing may be required in order to properly control the flow during engine operation, thus leading to high tolerance requirements. As a second example, it may be desirable to construct portions of the housing with a heat resistant material. However, when the housing is cast in a single piece, the entire housing is constructed with the selected heat resistant material, thereby raising costs. Additionally, the single cast piece has thermal-mechanical fatigue challenges due to the high temperatures experienced in the divider relative to the external walls which benefit from ambient convection.

In one approach a turbine is provided to address at least some of the above issues. The turbine includes a housing radially extending around a turbine rotor including a first piece defining a portion of a first scroll passage boundary and a second piece having an interface wall contiguous with an interface wall of the first piece, the second piece coupled to the first piece and including a divider defining another portion of the first scroll passage boundary and a portion of a second scroll passage boundary. In this way, it is possible to form boundaries of the first and second scroll passage, including a divider between the passages, with multiple pieces via the contiguous coupling at the interface wall, for example.

Using two pieces to form the housing of the turbine enables different mechanical attachment schemes for the twin scroll divider. Since the divider experiences more thermal expansion than other portions of the turbine, it can be designed to be attached with a scheme that allows thermal expansion. For example, in one embodiment a divider with slots and pins that enable the divider to slide over the pins in the direction of thermal expansion may be used. Other embodiments may include pins which are parallel or perpendicular to the divider. Further still in some embodiments, the divider may be flat or have a flange feature to accommodate the pin design. This loose fit reduces the thermal stress on the part and enables high temperature durability.

In one embodiment, such a configuration enables the first and second pieces of the housing respectively comprising different materials. For example, the first piece can be formed with different thermal expansion and/or heat resistance properties than the second piece. As a result, the longevity of the turbine can be increased without drastically increasing manufacturing costs of the turbine. For example, the divider may be manufactured from a material more resistant to thermal degradation, such as a ceramic material, than the material forming a remainder of the turbine housing. The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a schematic depiction of an engine including a turbocharger.

FIG. 2 shows an exploded view of an example turbine of the turbocharger shown in FIG. 1.

FIG. 3 shows an exploded view of another example turbine of the turbocharger shown in

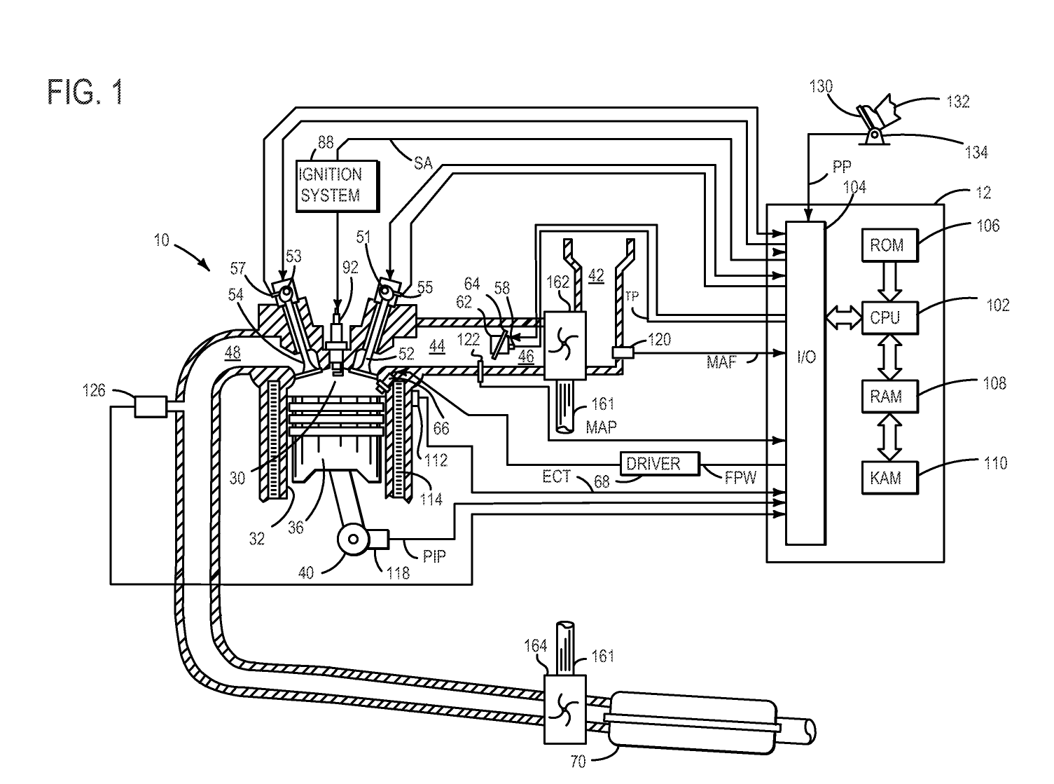

FIG. 1.

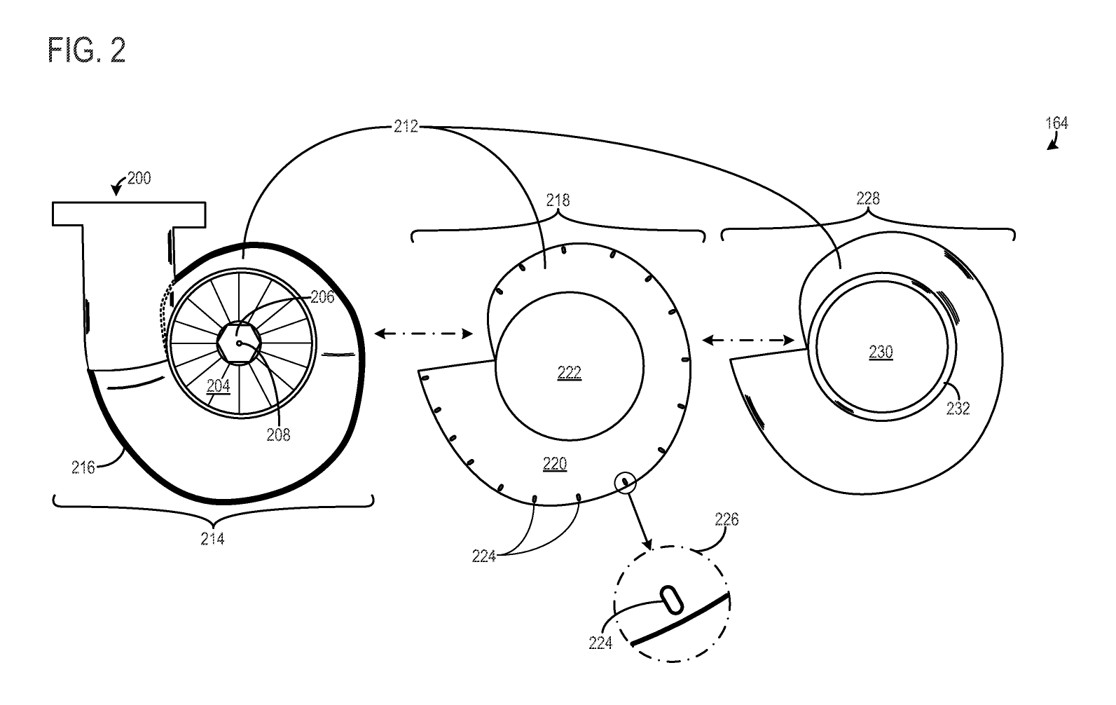

FIG. 4 shows an assembled view of the turbine shown in FIG. 2.

FIG. 5 shows a cross-sectional view of the turbine shown in FIG. 4.

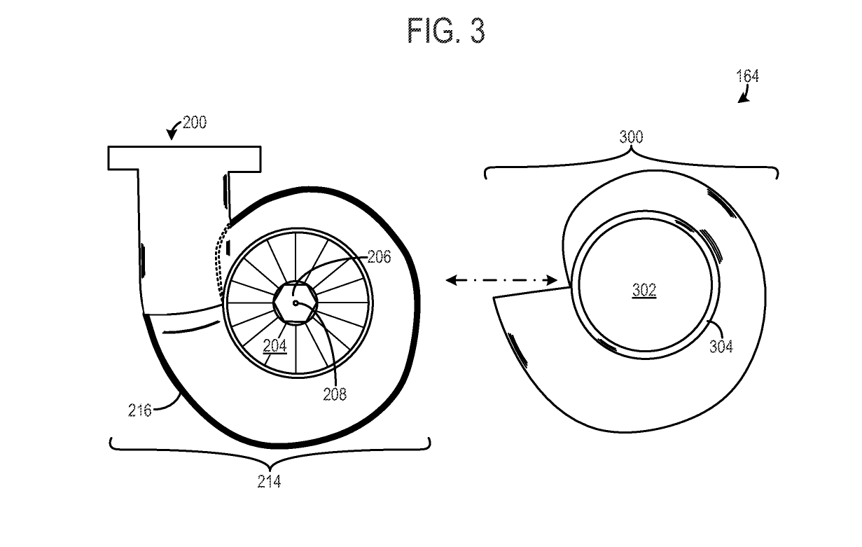

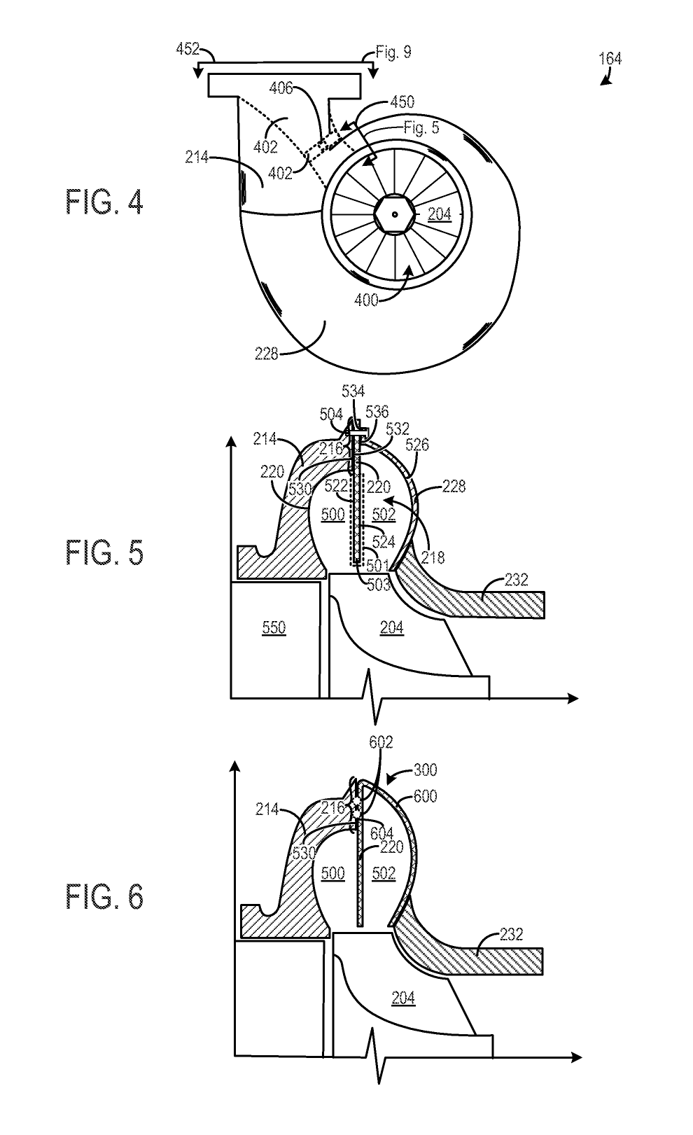

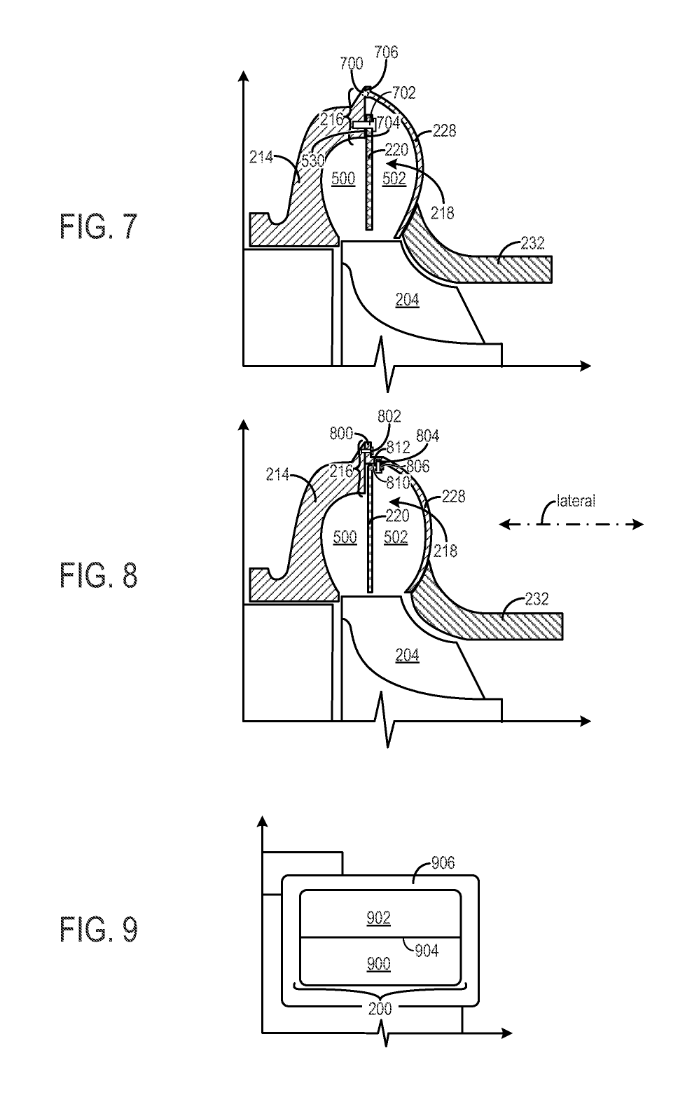

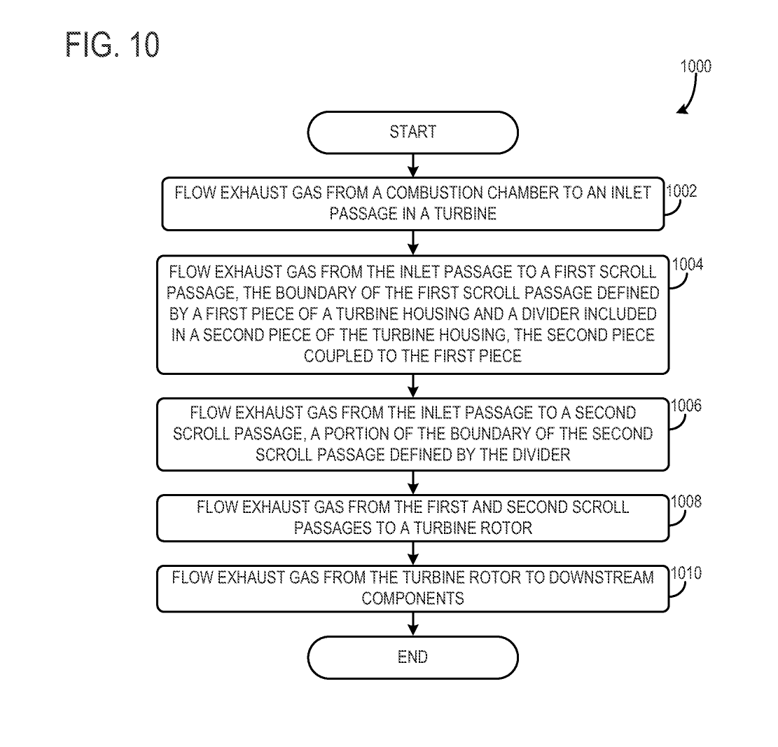

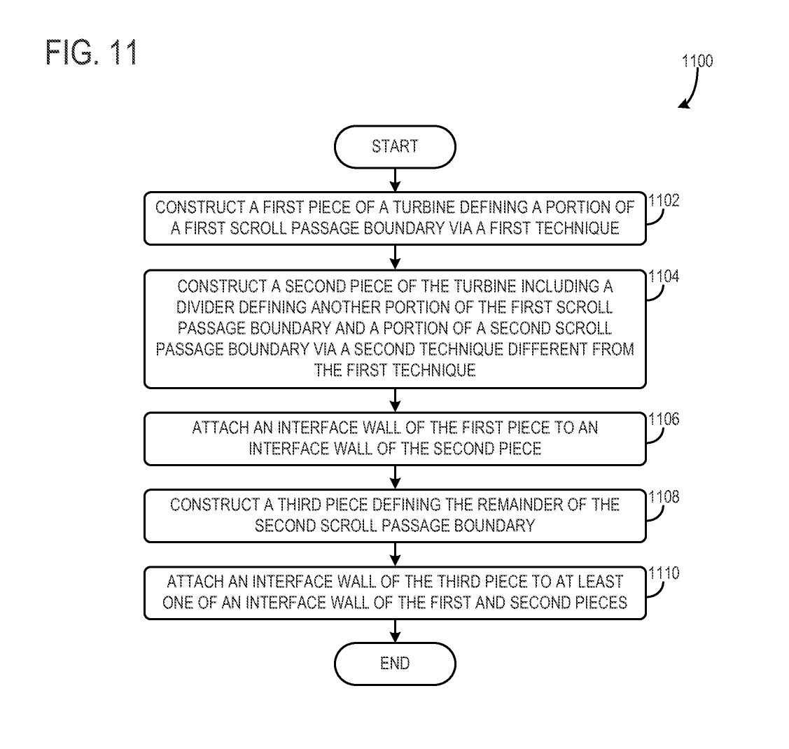

FIG. 6 shows a cross-sectional view of the turbine shown in FIG. 3.

FIGS. 7 and 8 show other embodiments of the coupling configuration of the first, second, and third pieces of the turbine housing shown in FIG. 2.

FIG. 9 shows a side view of the turbine shown in FIG. 4.

FIG. 10 shows a method for operation of the turbine.

FIG. 11 shows a method for manufacture of the turbine.

### DETAILED DESCRIPTION

A twin scroll turbine having a multi-piece construction is described herein. In one embodiment, the turbine may include a housing having a first piece coupled to the second piece, both pieces having respective interface walls contiguous with one another. The first piece, and a divider in the second piece, together may define a boundary of a first scroll passage. The divider may further define a portion of a boundary of a second scroll passage. The pieces of the housing may be manufactured from, and comprise, different materials. In this way, specific materials can be selected to improve heat resistance in certain areas of the turbine that are prone to thermal degradation.

Moreover, a method of manufacture of a turbine is also described herein. The method may include constructing the first and second pieces via separate construction techniques. For example, the first piece may be cast and the second piece may be stamped. In this way, separate pieces may be manufactured to meet separate tolerance requirements via different techniques. Therefore, pieces of the housing such, as the divider, may be constructed with smaller tolerance than other parts of the housing. As a result, the losses in the turbine may be decreased, thereby increasing the turbine's efficiency. Constructing a turbine with independent pieces also enables design of novel internal structures, such as a floating twin scroll divider.

Referring to FIG. 1, internal combustion engine 10, comprising a plurality of cylinders, one cylinder of which is shown in FIG. 1, is controlled by electronic engine controller 12. Engine 10 includes combustion chamber 30 and cylinder walls 32 with piston 36 positioned therein and connected to crankshaft 40. Combustion chamber 30 is shown communicating with intake manifold 44 and exhaust manifold 48 via respective intake valve 52 and exhaust valve 54. Each intake and exhaust valve may be operated by an intake cam 51 and an exhaust cam 53. Alternatively, one or more of the intake and exhaust valves may be operated by an electromechanically controlled valve coil and armature assembly. The position of intake cam 51 may be determined by intake cam sensor 55. The position of exhaust cam 53 may be determined by exhaust cam sensor 57.

Fuel injector 66 is shown positioned to inject fuel directly into cylinder 30, which is known to those skilled in the art as direct injection. Additionally or alternatively, fuel may be injected to an intake port, which is known to those skilled in the art as port injection. Fuel injector 66 delivers liquid fuel in proportion to the pulse width of signal FPW from controller 12. Fuel is delivered to fuel injector 66 by a fuel system (not shown) including a fuel tank, fuel pump, and fuel rail (not shown). Fuel injector 66 is supplied operating current from driver 68 which responds to controller 12. In addition, intake manifold 44 is shown communicating with optional electronic throttle 62 which adjusts a position of throttle plate 64 to control air flow from intake boost chamber 46. Compressor 162 draws air from air intake 42 to supply boost chamber 46. Exhaust gases spin turbine 164 which is coupled to compressor 162 via shaft 161. It will be appreciated that the turbine 164 is generically depicted via a box. However, as discussed in greater detail herein with regard to FIGS. 2-9, the turbine 164 has additional complexity. The compressor 162, shaft 161, and the turbine may be included in a turbocharger. A high pressure, dual stage, fuel system may be used to generate higher fuel pressures at injectors 66. However, other suitable injectors may be utilized.

Distributorless ignition system 88 provides an ignition spark to combustion chamber 30 via spark plug 92 in response to controller 12. Universal Exhaust Gas Oxygen (UEGO) sensor 126 is shown coupled to exhaust manifold 48 upstream of catalytic converter 70. Alternatively, a two-state exhaust gas oxygen sensor may be substituted for UEGO sensor 126.

Converter 70 can include multiple catalyst bricks, in one example. In another example, multiple emission control devices, each with multiple bricks, can be used. Converter 70 can be a three-way type catalyst in one example.

Controller 12 is shown in FIG. 1 as a conventional microcomputer including: microprocessor unit 102, input/output ports 104, read-only memory 106, random access memory 108, keep alive memory 110, and a conventional data bus. Controller 12 is shown receiving various signals from sensors coupled to engine 10, in addition to those signals previously discussed, including: engine coolant temperature (ECT) from temperature sensor 112 coupled to cooling sleeve 114; a position sensor 134 coupled to an accelerator pedal 130 for sensing accelerator position adjusted by foot 132; a knock sensor for determining ignition of end gases (not shown); a measurement of engine manifold pressure (MAP) from pressure sensor 122 coupled to intake manifold 44; an engine position sensor from a Hall effect sensor 118 sensing crankshaft 40 position; a measurement of air mass entering the engine from sensor 120 (e.g., a hot wire air flow meter); and a measurement of throttle position from sensor 58. Barometric pressure may also be sensed (sensor not shown) for processing by controller 12. In a preferred aspect of the present description, engine position sensor 118 produces a predetermined number of equally spaced pulses every revolution of the crankshaft from which engine speed (RPM) can be determined.

In some embodiments, the engine may be coupled to an electric motor/battery system in a hybrid vehicle. The hybrid vehicle may have a parallel configuration, series configuration, or variation or combinations thereof. Further, in some embodiments, other engine configurations may be employed, for example a diesel engine.

FIG. 2 shows an exploded view of a first configuration of the turbine 164. As previously discussed, the turbine 164 may be fluidly coupled to the combustion chamber 30, shown in FIG. 1, and therefore may receive exhaust gases therefrom to drive the turbine 164. the turbine 164 includes an inlet passage 200, shown in greater detail in FIG. 9. The rotor 204 may be coupled to the shaft 161, shown in FIG. 1, via friction or electron beam welding or another suitable attachment technique, in other embodiments. The turbine wheel has a hex shape 206 as part of the casing for assembly fixturing. The rotor 204 rotates about rotational axis 208.

The turbine 164 further includes a housing 212 having a multi-piece construction. The housing defines the flow path of exhaust gas through the turbine 164. It will be appreciated that the turbine rotor 204 is not included in the housing 212.

The turbine 164 includes a first piece 214. The first piece 214 may partially define a boundary of a first scroll channel 500, shown in FIG. 5 discussed in greater detail herein. The first piece 214 includes an attachment flange 216. The attachment flange 216 is positioned near the radial periphery of first piece 214 and the housing 212. In the depicted embodiment, the attachment flange 216 is substantially planar and is arranged perpendicular to the rotational axis 208 of the turbine rotor 204. However, it will be appreciated that in other embodiments the attachment flange 216 and/or inlet 200 may have a different contour and/or orientation. It will be appreciated that other pieces of the housing 212 may be coupled to the attachment flange when the turbine 164 is assembled.

As shown, the attachment flange 216 circumferentially extends around the turbine rotor 204 in a spiral shape. Specifically, in the depicted embodiment, the attachment flange 216 may extend substantially 360° around the turbine rotor 204. However, in other embodiments the attachment flange 216 may extend less than 360° degrees around the turbine rotor 204.

The turbine 164 further includes a second piece 218 having a divider 220. The divider 220 may define a portion of a boundary of the first scroll passage 500, shown in FIG. 5, and a portion of a boundary of a second scroll passage 502, shown in FIG. 5. The first scroll passage 500 may be referred to as a core-side scroll passage. Additionally, the second scroll passage 502 may be referred to as an outlet-side scroll passage. The second piece also includes a central opening 222. When assembled, the turbine rotor 204 is positioned in the central opening 222.

The second piece 218 may further include a plurality of radial pin openings 224. As shown, the radial pin openings 224 are slots having curved ends and a straight mid-section. However, other geometries may be used in other embodiments such as oval openings or round openings. An enlarged view of one of the radial pin openings 224 is shown at 226. It will be appreciated that when assembled, a plurality of radial pins may extend through the radial pin openings 224 coupling the first piece 214 to the second piece 218. Therefore, the radial pins may extend into the attachment flange. The radial pin openings 224 are radially aligned with the axis 208. However, other arrangements are possible in other embodiments. The radial pins and radial pin openings 224 (e.g., slots) may be designed so that the slot is in the orientation that enables thermal expansion. In the depicted embodiment the radial pin openings 224 are radially aligned. However, in other embodiments other orientations are possible. In this way, the divider 220 may be designed to accommodate thermal expansion and therefore may have a loose fit and exhibit “floating” characteristic. An example radial pin 54 in shown in FIG. 5. Another example, radial pin is show at 702 in FIG. 7.

It will be appreciated that the radial pins and corresponding radial pin openings may facilitate thermal expansion and contraction of the housing 212. In this way, the stress on second piece 218 (including divider 220) due expansion and contraction may be reduced. This may be particularly beneficial when the second piece 218 is at least partially constructed from a ceramic material, due to increased potential for shear stress damage to ceramic materials. Therefore, the likelihood of degradation (e.g., cracking) of the second piece 218 due to thermal expansion or contraction is reduced. In this way, ceramic material may be used without increased risk of the ceramic material failing due to expansion/contraction of the surrounding housing. It will be appreciated that ceramic material is more resistant to thermal degradation than metals.

The turbine 164 further includes a third piece 228. The third piece 228 may define a portion of the boundary of the second scroll passage 502, shown in FIG. 5. The third piece 228 may be coupled to at least one of the first and second pieces (214 and 218, respectively) when the turbine is assembled. The third piece 228 may be welded or bolted to the first piece 214. The third piece 228 defines a portion of the first scroll passage 500 and the second scroll passage 502, shown in FIG. 5. The third piece 228 includes a central opening 230 for gas exiting the turbine. When the turbine 164 is assembled, the turbine rotor may be positioned in the central opening 230. A turbine outlet flow guide 232 may be coupled to or included in the third piece 228. The turbine outlet flow guide 232 is configured to direct exhaust gas from the turbine rotor 204 to downstream components.

When assembled, the second piece 218 may be coupled to the first piece 214 via the attachment flange 216. Additionally, the third piece 228 may be coupled to the second piece 218 adjacent to the attachment flange 216 when assembled. However, it will be appreciated that other attachment configurations may be used and are discussed in greater detail herein with regard to FIGS. 6-8.

The first and second pieces (214 and 218, respectively) may comprise a material such as steel. However, in some embodiments the first and second pieces (214 and 218, respectively) may comprise different materials. For example, at least a portion of the second piece 218, such as the divider 220, may be constructed out of a ceramic material and the first piece may be constructed out of a metal such as steel. It will be appreciated that ceramic materials are more resistant to temperature than metal. Therefore, in some embodiments, a ceramic material may be used to construct the divider 220 that experiences high temperature exhaust gas flow, to reduce the likelihood of thermal degradation of the divider. As a result, the longevity of the turbine 164 is increased.

Furthermore, the first piece 214 and second piece 218 may be manufactured via different techniques. For example, the first piece 214 may be constructed via casting and the second piece 218 may be constructed via stamping or hydroforming. The third piece 228 may also be manufactured via stamping or alternatively may be manufactured via casting. It will be appreciated that the desired tolerances of the first piece 214 may be greater than the second piece 218. Moreover, the tolerances of a stamped component may be less than the tolerances of a cast component. Therefore, the first piece 214 may be cast and the second piece 218 may be stamped. Thus, when the divider 220 is stamped the tolerances are reduced when compared to casting. As a result, a desired flow pattern may be achieved in the turbine scrolls, thereby decreasing losses within the turbine and increasing the turbocharger's efficiency. Furthermore, casting is a less expensive manufacturing method than stamping. In this way, the turbocharger's efficiency may be increased while reducing manufacturing costs.

FIG. 3 shows a second example of the turbine 164 including similar components, as shown in FIG. 2. Therefore, corresponding components are labeled accordingly. As shown, the turbine 164 shown in FIG. 3 includes the first piece 214 having the attachment flange 216 for coupling other pieces thereto. The first piece 214 includes the inlet passage 200. The turbine 164, shown in FIG. 3, also includes the turbine rotor 204. However, in FIG. 3 the turbine 164 does not include a third piece. It will be appreciated that the second and third pieces (218 and 228, respectively) shown in FIG. 2, form a continuous second piece 300 in FIG. 3. The second piece 300 includes an opening 302 and a turbine outlet flow guide 304. The turbine outlet flow guide 232 is configured to direct exhaust gas from the turbine rotor 204 to downstream components. It will be appreciated that the second piece 300 may be coupled (e.g., by bolt or weld) to the first piece 214 via attachment flange 216 when assembled. In some examples, the second piece 300 may be hydroformed.

FIG. 4 shows the turbine 164 of FIG. 2 assembled. As previously discussed, the second piece 218 is coupled to the first piece 214 via attachment flange 216 and the third piece 228 is coupled to the second piece 218 when the turbine 164 is assembled. Therefore, the second piece 218 is interposed via the first piece 214 and the third piece 228 in the turbine 164 in this example. Thus, in the view shown in FIG. 4 the second piece 218 is not visible and is below the third piece 228 with respect to an axis extending into and out of the page. The turbine 164 further includes an outlet passage 400 configured to receive exhaust gas from a turbine rotor 204. It will be appreciated that the turbine outlet flow guide 232 defines a portion of the boundary of the outlet passage 400.

In some embodiments, the turbine 164 may include a bypass passage 402 fluidly coupled upstream and downstream of the turbine rotor 204. A wastegate 404 including an actuation mechanism 406 may be positioned in the bypass passage 402. The wastegate 404 may be configured to adjust the flow of exhaust gas through the bypass passage 402. Therefore, in some embodiments exhaust gas flow through the bypass passage 402 may be substantially inhibited during certain operating conditions. Cutting plane 450 defines the cross-section shown in FIG. 5 and plane 452 defines the view shown in FIG. 9.

FIG. 5 shows a cross-sectional view of the turbine 164. The first piece 214, the second piece 218 including the divider 220, and the third piece 228 of the housing 212 are shown. The first piece 214 extends axially, with regard to the rotational axis of the turbine 164, from a shaft housing 550 to a portion of the turbine rotor 204 in the depicted embodiment. The shaft housing 550 may at least partially circumferentially surround a shaft coupling the turbine rotor 204 to a compressor rotor included in the compressor 162 shown in FIG. 1. The shaft housing may include one or more bearings having inner and outer races, rolling elements, etc.

The second piece 218 and third piece 228 extends axially, with regard to the rotational axis of the turbine 164, from a first portion of the turbine rotor 204 to a second portion of the turbine rotor 204, in the depicted embodiment. However, in other embodiments the second piece 218 or third piece 228 may include the turbine flow guide 232 and therefore may extend axially past the turbine rotor 204.

An interface wall 530 of the first piece 214 and an interface wall 532 of the second piece 218 are shown. The interface wall 530 and the interface wall 532 are contiguous Likewise, the third piece 228 includes an interface wall 534 that is contiguous with another interface wall 536 of the second piece 218. However, the interface wall 534 may be contiguous with the interface wall 530 in other embodiments. The second piece 218 may be referred to as an outlet-side housing. On the other hand, the first piece 214 may be referred to as a core-side housing. It will be appreciated that the core-side housing is separate from the outlet-side housing.

The first scroll passage 500 and the second scroll passage 502 are also illustrated in FIG. 5. The boundary of the first scroll passage 500 is partially defined via the first piece 214. Specifically, the first piece 214 includes a core-side wall 520 defining a portion of the first scroll passage 500.

The remainder of the boundary of the first scroll passage 500 is defined via a core-side wall 522 of the divider 220. In this way, a portion of the boundary of the first scroll passage 500 is defined by the divider 220 and a portion of the boundary of the first scroll passage 500 is defined by the first piece 214. On the other hand, the boundary of the second scroll passage 502 is defined by the divider 220 and the third piece 228. Specifically, an outlet-side wall 524 of the divider 220 defines a portion of the boundary of the second scroll passage 502 and an outlet-side wall 526 of the third piece 228 defines the remainder of the boundary of the second scroll passage 502.

It will be appreciated that exhaust flow from the first and second scroll passages (500 and 502, respectively) is directed to the turbine rotor 204. In some embodiments, a heat resistant coating 501 may be on a surface of the divider 220. The divider 220 includes an end 503 adjacent to the turbine rotor 204. In some embodiments, the end 503 is less than 0.2 mm from the turbine rotor 204. However, in other embodiments other separation distances are possible. When, the separation of the rotor 204 and the divider 220 is reduced the losses in the turbine are decreased, thereby increasing the turbine's pulse capture and efficiency. It will be appreciated that when the divider 220 is constructed via stamping this degree of separation of the divider 220 and the turbine rotor 204 may be achieved. Specifically, stamping may enable the divider to be constructed with a 0.2 mm tolerance, while casting may allow the divider to be constructed with a 1.5 mm tolerance. Furthermore, when stamping is used to construct the divider 220, the width of the divider may be decreased when compared to manufacturing techniques such as casting. When the width of the divider is decreased, exhaust gas is more efficiently delivered to the turbine, thereby decreasing losses and increasing the turbine's efficiency.

As shown, the divider 220 is coupled to the attachment flange 216 via radial pin 504 extending through the divider 220 and into the attachment flange 216. Specifically, the radial pin 504 is perpendicular to the divider 200. However other radial pin alignments are possible. In some embodiments, the radial pin 504 may be a screw which may have an 8 mm diameter. However, other suitable pins having other measurements may be used. The radial pin 504 also extends through the third piece 228. It will be appreciated that a plurality of radial pins positioned at other radial locations may also extend through the divider 220 and the third piece 228 and into the attachment flange 216 through the radial pin openings 224. Additionally or alternatively, the divider 220 may be welded to the first piece 214 or attached via another suitable attachment mechanism. Likewise, the third piece 228 may be welded to the divider 220.

FIG. 5 further includes the turbine outlet flow guide 232 coupled to the third piece 228. In some embodiments, the turbine outlet flow guide 232 may be integrated into the third piece 228 and other embodiments it may be part of the first piece 214. In other words, the turbine outlet flow guide 232 and third piece 228 or the turbine outlet flow guide 232 and the first piece 214 may be jointly constructed. The turbine outlet flow guide 232 may be configured to direct exhaust gas from the turbine to downstream components.

FIG. 6 shows a cross-sectional view of another example of the turbine 164 shown in FIG. 3. As shown, the second piece 300 includes the divider 220 as well as a wall 600 defining another portion of the boundary of the second scroll passage 502. Thus the second piece defines the boundary of the entire second scroll passage 502. As shown, the second piece 300 is welded via welds 602 to the first piece 214. However, additional or alternative connections techniques may be used. For example, one or more bolts or radial pins may be used to couple the second piece 300 to the first piece 214. The turbine outlet flow guide 232 is also shown coupled to the second piece 300 in FIG. 6. However, it will be appreciated that the turbine outlet flow guide 232 and the second piece 300 may be jointly manufactured (e.g., cast) in other embodiments. FIG. 6 shows the interface wall 530 of the flange 216 if in face sharing contact and contiguous with interface wall 604 of the second piece 300.

FIGS. 7 and 8 show other coupling configurations that may be used to attach the first piece 214, the second piece 218 including the divider 220, and the third piece 228 in the turbine 164. Specifically, FIG. 7 shows both the divider 220 and the third piece 228 coupled to the attachment flange 216. As shown, a weld 700 is used to couple the third piece 228 to the first piece 214 and a pin 702 is used to couple the divider 220 to the first piece 214. The pin 702 may be a screw having a 2 mm diameter and a 4 mm head. However, other suitable pins having alternate measurements may be used. Pin 702 may extend through an opening such as one of the radial pin opening 224, shown in FIG. 2. The opening enables thermal growth over the pin 702. However, it will be appreciated that additional or alternate coupling techniques may be used attach the pieces directly to one another. The turbine outlet flow guide 232 is also shown coupled to the third piece 228 in FIG. 7. However, it will be appreciated that the turbine outlet flow guide 232 and the third piece 228 may be jointly manufactured (e.g., cast) in other embodiments. FIG. 7 shows the interface wall 530 of the flange 216 if in face sharing contact and contiguous with interface wall 704 of the divider 220. Additionally, FIG. 7 shows the interface wall 530 of the flange 216 if in face sharing contact and contiguous with interface wall 706 of the third piece 228.

FIG. 8 shows another example coupling configuration for the first piece 214, the divider 220, and the third piece 228. As shown, the third piece 228 is coupled to the attachment flange 216 and the divider 220 is coupled to the third piece 228. As shown, the third piece 228 includes a flange 800 through which bolt 802 extends. However, in other embodiments the third piece 228 may be welded to flange 800 or a pin may extend through the third piece 228 and the flange 800. The bolt 802 also extends into the attachment flange 216. The flange 216 is radially aligned with the rotational axis 208, shown in FIG. 2, of turbine rotor 204 in the depicted embodiment. However, in other embodiments, the position and or geometric characteristics of the flange may be altered. Furthermore, it will be appreciated that alternate or additional attachment techniques may be used to couple the third piece 228 to the first piece 214.

The divider 220 is coupled to the third piece 228 via a pin 804 or other suitable attachment technique such as a bolt. The pin 804 extends through a flange 806 included in the third piece 228 and may be rigidly attached. Moreover, the pin 804 is parallel to the divider 220. However, other pin alignments are possible. The flange 806 is planar and is laterally aligned and substantially parallel to the rotational axis 208, shown in FIG. 2. However, in other embodiments the flange 806 may have another shape and/or orientation. The turbine outlet flow guide 232 is also shown coupled to the third piece 228 in FIG. 8. FIG. 8 shows the interface wall 810 of the divider 220 if in face sharing contact and contiguous with interface wall 812 of the third piece 228. This alignment of interface wall 810 enables holes (e.g., round holes) over pins which can slip to account for thermal expansion of divider 220.

FIG. 9 shows a view of the inlet passage 200 of the turbine 164, shown in FIG. 2. It will be appreciated that the inlet passage 200 in the turbine shown in FIG. 2 may be similar to the inlet passage 200 in the turbine 164 shown in FIG. 3. The inlet passage 200 includes a first section 900 and a second section 902 fluidly separated from the first section. Wall 904 divides the first section 900 from the second section 902. In this way, the first section 900 is fluidly separated from the second section 902 via wall 904. However, in other embodiments the wall 904 may not be included in the turbine 164. The first section 900 is in fluidic communication with the first scroll passage 500, shown in FIG. 4 and the second section 902 is in fluidic communication with the second scroll passage 502, shown in FIG. 4. A flange 906 may extend around the inlet passage 200. The flange 906 may be coupled to various upstream components such as an exhaust passage, exhaust manifold, etc., via a suitable attachment apparatus (e.g., bolts, welds, etc.)

FIG. 10 shows a method 1000 for operation of a turbine. Method 1000 may be implemented via the turbine described above with regard to FIGS. 1-9 or may be implemented via another suitable turbine.

At 1002 the method includes flowing exhaust gas from a combustion chamber to an inlet passage in a turbine. At 1004 the method include flowing exhaust gas from the inlet passage to a first scroll passage, the boundary of the first scroll passage defined by a first piece of a turbine housing and a divider included in a second piece of the turbine housing, the second piece coupled to the first piece.

At 1006 the method includes flowing exhaust gas from the inlet passage to a second scroll passage, a portion of the boundary of the second scroll passage defined by the divider. In some examples, another portion of the boundary of the second scroll passage is defined by a third piece.

At 1008 the method includes flowing exhaust gas from the first and second scroll passages to a turbine rotor and at 1010 the method includes flowing exhaust gas from the turbine rotor to downstream components.

FIG. 11 shows a method 1100 for manufacturing a turbine. Method 1100 may be used to manufacture the turbine described above or may be used to manufacture another suitable turbine. At 1102 the method includes constructing a first piece of a turbine defining a portion of a first scroll passage boundary via a first technique.

At 1104 the method includes constructing a second piece of the turbine including a divider defining another portion of the first scroll passage boundary and a portion of a second scroll passage boundary via a second technique different from the first technique. In some examples, the first piece is constructed via casting and the second piece is constructed via one of the techniques of stamping and hydoforming. Therefore, the tolerances of the first piece may be greater than the tolerances of the second piece. Next, at 1106 the method includes attaching an interface wall of the first piece to an interface wall of the second piece.

The method may include at 1108 constructing a third piece defining the remainder of the second scroll passage boundary and at 1110 attaching an interface wall of the third piece to at least one of an interface wall of the first and second pieces. However, in other embodiments, steps 1108 and 1110 may be omitted from the method 1100.

As will be appreciated by one of ordinary skill in the art, the method described in FIGS. 10 and 11 may represent one or more of any number of processing strategies such as event-driven, interrupt-driven, multi-tasking, multi-threading, and the like. As such, various steps or functions illustrated may be performed in the sequence illustrated, in parallel, or in some cases omitted. Likewise, the order of processing is not necessarily required to achieve the objects, features, and advantages described herein, but is provided for ease of illustration and description. Although not explicitly illustrated, one of ordinary skill in the art will recognize that one or more of the illustrated steps or functions may be repeatedly performed depending on the particular strategy being used.

This concludes the description. The reading of it by those skilled in the art would bring to mind many alterations and modifications without departing from the spirit and the scope of the description. For example, single cylinder, I2, I3, I4, I5, I6, V4, V6, V8, V10, V12 and V16 engines operating in natural gas, gasoline, diesel, or alternative fuel configurations could use the present description to advantage.

1. A turbine comprising:
a housing radially extending around a turbine rotor including:
a first piece defining a portion of a first scroll passage boundary; and
a second piece having an interface wall contiguous with an interface wall of the first piece, the second piece coupled to the first piece and including a divider defining another portion of the first scroll passage boundary and a portion of a second scroll passage boundary.

2. The turbine of claim 1, wherein the first piece includes an attachment flange positioned adjacent to a radial periphery of the housing, and where the first piece comprises a different material than the second piece.

3. The turbine of claim 2, wherein the second piece is coupled to the attachment flange.

4. The turbine of claim 1, wherein the second piece defines the entire boundary of the second scroll passage.

5. The turbine of claim 1, further comprising a third piece coupled to at least one of the first and second pieces, the third piece defining the remainder of the second scroll passage boundary.

6. The turbine of claim 1, wherein the first piece defines a boundary of an inlet passage.

7. The turbine of claim 1, wherein the second piece comprises a ceramic material.

8. The turbine of claim 1, wherein the second piece includes a heat resistant coating on a surface of the divider.

9. The turbine of claim 1, further comprising a wastegate integrated into the first piece of the housing, the wastegate configured to adjust exhaust gas flow delivered to a bypass passage.

10. The turbine of claim 1, wherein the second piece is coupled to the first piece via a bolt or a pin.

11. The turbine of claim 1, wherein the first piece is coupled to the second piece via one or more radial pins or bolts.

12. The turbine of claim 1, wherein the divider defines the remainder of the first scroll passage boundary.

13. A turbine comprising:
a core-side housing defining a core-side wall of a first core-side scroll passage;
a, separate, outlet-side housing defining an outlet-side wall of a second outlet-side scroll passage, the core-side housing sharing an interface wall with the outlet-side housing; and
a divider coupled to one or more of the core-side and outlet-side housings forming walls of both the first and second scroll passages.

14. The turbine of claim 16, wherein the outlet-side housing includes a divider constructed out of ceramic material and coupled to the core-side housing via one or more radial pins.

15. The turbine of claim 16, wherein the core-side housing comprises a different material than the outlet-side housing.

16. A method for manufacturing a turbine comprising:
constructing a first piece of a turbine defining a portion of a first scroll passage boundary via a first technique;
constructing a second piece of the turbine including a divider defining another portion of the first scroll passage boundary and a portion of a second scroll passage boundary via a second technique different from the first technique; and
attaching an interface wall of the first piece to an interface wall of the second piece.

17. The method for manufacturing of claim 19, wherein the first piece is constructed via casting and the second piece is constructed via one of stamping and hydoforming.

18. The method for manufacturing of claim 19, further comprising;
constructing a third piece defining the remainder of the second scroll passage boundary; and
attaching an interface wall of the third piece to at least one of an interface wall of the first and second pieces.
